(19) United States
(12) Patent Application Publication
(10) Pub. No.: US 2022/0043646 A1
(43) Pub. Date: Feb. 10, 2022

(54) SYSTEM FOR FACILITATING SOFTWARE CODE BUILD AND REVIEW WITH REAL-TIME ERROR FEEDBACK

(71) Applicant: BANK OF AMERICA CORPORATION, Charlotte, NC (US)

(72) Inventors: Thomas Boffin James, Mumbai (IN); Lalbahadur Kailashnath Gupta, Mumbai (IN); Amrut Gopal Nayak, Mumbai (IN)

(73) Assignee: BANK OF AMERICA CORPORATION, Charlotte, NC (US)

(21) Appl. No.: 16/985,543

(22) Filed: Aug. 5, 2020

(51) Int. Cl. G06F 8/65; G06F 8/30; G06F 8/73; G06N 5/04; G10L 15/22; G06F 16/9035; G06F 16/9038

(52) U.S. Cl. CPC G06F 8/65; G06F 8/30; G06F 8/73; G06F 16/9038; G10L 15/22; G06F 16/9035; G06N 5/04

(57) ABSTRACT

Embodiments of the present invention provide a system for providing real-time feedback during software code build and review sessions. The system is configured for determining that a first user is accessing a review session user interface via a user device, determining initiation of a first review session from the user device by the first user, wherein the first review session involves review of a software code associated with an entity application that is developed by at least one of the first user and a plurality of users, continuously capturing the first review session in real-time, via the user device, in response to capturing the first review session, process the first review session, and generating a recommendation based on processing the first review session.

### BACKGROUND

Conventional systems do not have the capability to provide real-time feedback in software code build and review sessions. As such, there exists a need for a system that facilitates software code build and review with real-time feedback.

### BRIEF SUMMARY

The following presents a summary of certain embodiments of the invention. This summary is not intended to identify key or critical elements of all embodiments nor delineate the scope of any or all embodiments. Its sole purpose is to present certain concepts and elements of one or more embodiments in a summary form as a prelude to the more detailed description that follows.

Embodiments of the present invention address the above needs and/or achieve other advantages by providing apparatuses (e.g., a system, computer program product and/or other devices) and methods for providing real-time feedback during software code build and review sessions. The system embodiments may comprise one or more memory devices having computer readable program code stored thereon, a communication device, and one or more processing devices operatively coupled to the one or more memory devices, wherein the one or more processing devices are configured to execute the computer readable program code to carry out the invention. In computer program product embodiments of the invention, the computer program product comprises at least one non-transitory computer readable medium comprising computer readable instructions for carrying out the invention. Computer implemented method embodiments of the invention may comprise providing a computing system comprising a computer processing device and a non-transitory computer readable medium, where the computer readable medium comprises configured computer program instruction code, such that when said instruction code is operated by said computer processing device, said computer processing device performs certain operations to carry out the invention.

In some embodiments, the present invention determines that a first user is accessing a review session user interface via a user device, determines initiation of a first review session from the user device by the first user, wherein the first review session involves review of a software code associated with an entity application that is developed by at least one of the first user and a plurality of users, continuously captures the first review session in real-time, via the user device, in response to capturing the first review session, processes the first review session, and generates a recommendation based on processing the first review session.

In some embodiments, the present invention generates a summary of the first review session, displays the summary on the review session user interface, and transmits the summary to the first user and the plurality of users.

In some embodiments, the present invention identifies one or more review comments associated with the software code from the first review session and publishes the one or more review comments in a code review standards page.

In some embodiments, the present invention displays the code review standards page to the first user and the plurality of users via the review session user interface, prompts the first user and the plurality of users to submit feedback associated with the one or more review comments in the code review standards page, receives the feedback from at least one of the first user and the plurality of users, and updates the code review standards page based on the feedback.

In some embodiments, the present invention stores the one or more review comments in a review comments database.

In some embodiments, the present invention stores recording associated with the first review session in a recording database.

In some embodiments, the present invention in response to determining that the first user is accessing the review session interface, prompts the first user to provide a voice input, associates the voice input with credentials of the first user, and stores the voice input in the code review session database.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described embodiments of the invention in general terms, reference will now be made the accompanying drawings, wherein:

FIG. 1 provides a block diagram illustrating a system environment for providing real-time feedback during software code build and review sessions, in accordance with an embodiment of the invention;

FIG. 2 provides a block diagram illustrating the entity system 200 of FIG. 1, in accordance with an embodiment of the invention;

FIG. 3 provides a block diagram illustrating a real-time code review system 300 of FIG. 1, in accordance with an embodiment of the invention;

FIG. 4 provides a block diagram illustrating the computing device system 400 of FIG. 1, in accordance with an embodiment of the invention;

FIG. 5 provides a flowchart illustrating a process flow for providing real-time feedback during software code build and review sessions, in accordance with an embodiment of the invention;

FIG. 6 provides a block diagram illustrating an architecture for providing real-time feedback during software code build and review sessions, in accordance with an embodiment of the invention;

FIG. 7 provides a block diagram illustrating an architecture for capturing real-time review sessions, in accordance with an embodiment of the invention;

FIG. 8 provides a block diagram illustrating an architecture for processing the real-time review sessions, in accordance with an embodiment of the invention; and

FIG. 9 provides a block diagram illustrating an architecture for publishing code review standards in an code review standards page, in accordance with an embodiment of the invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

In accordance with embodiments of the invention, the terms “resource entity” or “entity” may include any organization that uses, develops, maintains, and/or controls application software to perform one or more organizational activities. In an exemplary embodiment, the resource entity may be an organization that processes financial transactions including, but not limited to, banks, credit unions, savings and loan associations, card associations, settlement associations, investment companies, stock brokerages, resource management firms, insurance companies and the like. In another exemplary embodiment, the resource entity may be a non-financial institution. Furthermore, embodiments of the present invention use the term “end user” or “customer.” It will be appreciated by someone with ordinary skill in the art that the user may be a customer of the entity or a potential customer of the entity or an employee of the financial institution. Embodiments of the present invention use the term “associate” or “user.” In some embodiments, the end user may be an associate. It will be appreciated by someone with ordinary skill in the art that the associate may be an employee of the entity.

Many of the example embodiments and implementations described herein contemplate interactions engaged in by a user with a computing device and/or one or more communication devices and/or secondary communication devices. Furthermore, as used herein, the term “user computing device” or “mobile device” may refer to mobile phones, computing devices, tablet computers, wearable devices, smart devices and/or any portable electronic device capable of receiving and/or storing data therein.

A “user interface” is any device or software that allows a user to input information, such as commands or data, into a device, or that allows the device to output information to the user. For example, the user interface include a graphical user interface (GUI) or an interface to input computer-executable instructions that direct a processing device to carry out specific functions. The user interface typically employs certain input and output devices to input data received from a user, second user or output data to a user. These input and output devices may include a display, mouse, keyboard, button, touchpad, touch screen, microphone, speaker, LED, light, joystick, switch, buzzer, bell, and/or other user input/output device for communicating with one or more users.

A “system environment”, as used herein, may refer to any information technology platform of an enterprise (e.g., a national or multi-national corporation) and may include a multitude of servers, machines, mainframes, personal computers, network devices, front and back end systems, database system and/or the like.

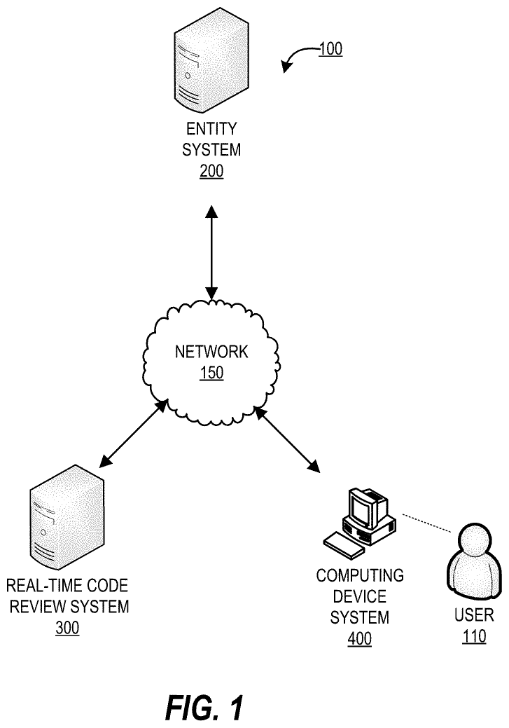

FIG. 1 provides a block diagram illustrating a system environment 100 for providing real-time feedback during software code build and review sessions, in accordance with an embodiment of the invention. As illustrated in FIG. 1, the environment 100 includes a real-time code review system 300, an entity system 200, and a computing device system 400. One or more users 110 may be included in the system environment 100, where the users 110 interact with the other entities of the system environment 100 via a user interface of the computing device system 400.

The entity system(s) 200 may be any system owned or otherwise controlled by an entity to support or perform one or more process steps described herein. In some embodiments, the entity is a financial institution. In some embodiments, the entity may be any organization that develops software code associated with software applications. In some embodiments, the one or more user(s) 110 of the system environment 100 may be employees of an entity associated with the entity system 200. In some embodiments, the one or more user(s) 110 may be application developers, testers, application owners, or the like.

The real-time code review system 300 is a system of the present invention for performing one or more process steps described herein. In some embodiments, the real-time code review system 300 may be an independent system. In some embodiments, the real-time code review system 300 may be a part of the entity system 200.

The real-time code review system 300, the entity system 200, and the computing device system 400 may be in network communication across the system environment 100 through the network 150. The network 150 may include a local area network (LAN), a wide area network (WAN), and/or a global area network (GAN). The network 150 may provide for wireline, wireless, or a combination of wireline and wireless communication between devices in the network. In one embodiment, the network 150 includes the Internet. In general, the real-time code review system 300 is configured to communicate information or instructions with the entity system 200, and/or the computing device system 400 across the network 150.

The computing device system 400 may be a system owned or controlled by the entity of the entity system 200 and/or the user 110. As such, the computing device system 400 may be a computing device of the user 110. In general, the computing device system 400 communicates with the user 110 via a user interface of the computing device system 400, and in turn is configured to communicate information or instructions with the real-time code review system 300, and/or entity system 200 across the network 150.

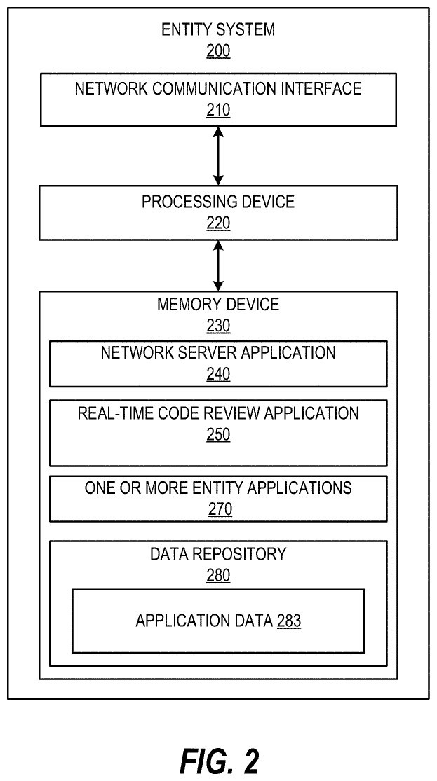

FIG. 2 provides a block diagram illustrating the entity system 200, in greater detail, in accordance with embodiments of the invention. As illustrated in FIG. 2, in one embodiment of the invention, the entity system 200 includes one or more processing devices 220 operatively coupled to a network communication interface 210 and a memory device 230. In certain embodiments, the entity system 200 is operated by a first entity, such as a financial institution.

It should be understood that the memory device 230 may include one or more databases or other data structures/repositories. The memory device 230 also includes computer-executable program code that instructs the processing device 220 to operate the network communication interface 210 to perform certain communication functions of the entity system 200 described herein. For example, in one embodiment of the entity system 200, the memory device 230 includes, but is not limited to, a real-time code review application 250, one or more entity applications 270, and a data repository 280 comprising information associated with application data 283. The one or more entity application 270 may be any applications that are being developed/tested by the entity of the entity system 200. Application data 283 may comprise any data associated with the one or more entity application that are developed and/or tested by the entity of the entity system 200. The computer-executable program code of the network server application 240, the real-time code review application 250, the one or more entity application 270 to perform certain logic, data-extraction, and data-storing functions of the entity system 200 described herein, as well as communication functions of the entity system 200.

The network server application 240, the real-time code review application 250, and the one or more entity applications 270 are configured to store data in the data repository 280 or to use the data stored in the data repository 280 when communicating through the network communication interface 210 with the real-time code review system 300, and/or the computing device system 400 to perform one or more process steps described herein. In some embodiments, the entity system 200 may receive instructions from the real-time code review system 300 via the real-time code review application 250 to perform certain operations. The real-time code review application 250 may be provided by the real-time code review system 300. The one or more entity applications 270 may be any of the applications used, created, modified, facilitated, and/or managed by the entity system 200.

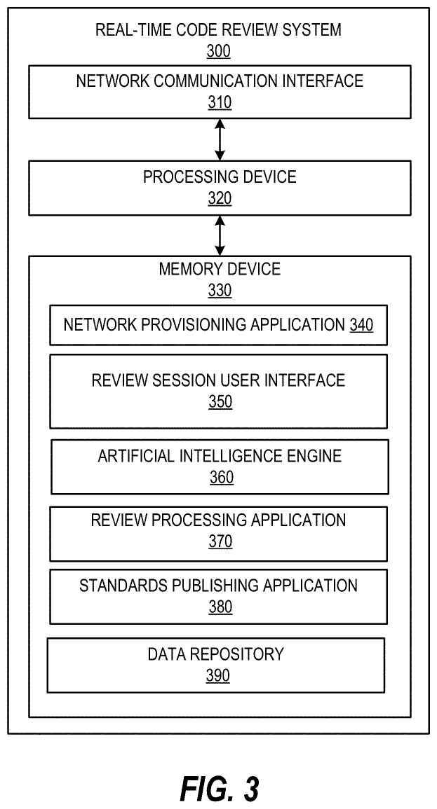

FIG. 3 provides a block diagram illustrating the real-time code review system 300 in greater detail, in accordance with embodiments of the invention. As illustrated in FIG. 3, in one embodiment of the invention, the real-time code review system 300 includes one or more processing devices 320 operatively coupled to a network communication interface 310 and a memory device 330. In certain embodiments, the real-time code review system 300 is operated by an entity, such as a financial institution. In some embodiments, the real-time code review system 300 is owned or operated by the entity of the entity system 200. In some embodiments, the real-time code review system 300 may be an independent system. In alternate embodiments, the real-time code review system 300 may be a part of the entity system 200.

It should be understood that the memory device 330 may include one or more databases or other data structures/repositories. The memory device 330 also includes computer-executable program code that instructs the processing device 320 to operate the network communication interface 310 to perform certain communication functions of the real-time code review system 300 described herein. For example, in one embodiment of the real-time code review system 300, the memory device 330 includes, but is not limited to, a network provisioning application 340, a review session user interface 350, an artificial intelligence engine 360, a review processing application 370, a standards publishing application 380, and a data repository 390 comprising data processed or accessed by one or more applications in the memory device 330. The computer-executable program code of the network provisioning application 340, the review session user interface 350, the artificial intelligence engine 360, the review processing application 370, and the standards publishing application 380 may instruct the processing device 320 to perform certain logic, data-processing, and data-storing functions of the real-time code review system 300 described herein, as well as communication functions of the real-time code review system 300.

The network provisioning application 340, the review session user interface 350, the artificial intelligence engine 360, the review processing application 370, and the standards publishing application 380 are configured to invoke or use the data in the data repository 390 when communicating through the network communication interface 310 with the entity system 200, and/or the computing device system 400. In some embodiments, the network provisioning application 340, the review session user interface 350, the artificial intelligence engine 360, the review processing application 370, and the standards publishing application 380 may store the data extracted or received from the entity system 200, and the computing device system 400 in the data repository 390. In some embodiments, the network provisioning application 340, the review session user interface 350, the artificial intelligence engine 360, the review processing application 370, and the standards publishing application 380 may be a part of a single application.

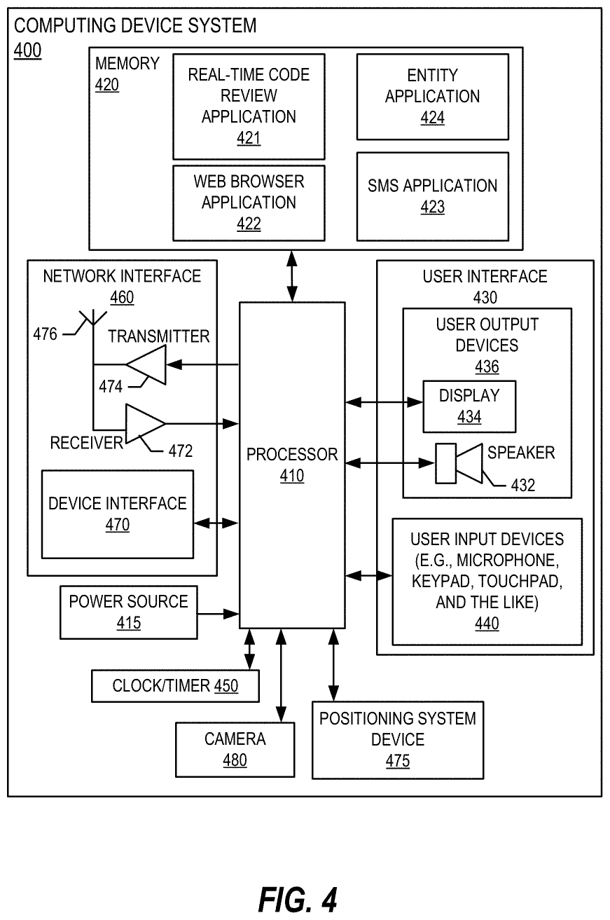

FIG. 4 provides a block diagram illustrating a computing device system 400 of FIG. 1 in more detail, in accordance with embodiments of the invention. However, it should be understood that a mobile telephone is merely illustrative of one type of computing device system 400 that may benefit from, employ, or otherwise be involved with embodiments of the present invention and, therefore, should not be taken to limit the scope of embodiments of the present invention. Other types of computing devices may include portable digital assistants (PDAs), pagers, mobile televisions, gaming devices, desktop computers, workstations, laptop computers, cameras, video recorders, audio/video player, radio, GPS devices, wearable devices, Internet-of-things devices, augmented reality devices, virtual reality devices, automated teller machine devices, electronic kiosk devices, or any combination of the aforementioned.

Some embodiments of the computing device system 400 include a processor 410 communicably coupled to such devices as a memory 420, user output devices 436, user input devices 440, a network interface 460, a power source 415, a clock or other timer 450, a camera 480, and a positioning system device 475. The processor 410, and other processors described herein, generally include circuitry for implementing communication and/or logic functions of the computing device system 400. For example, the processor 410 may include a digital signal processor device, a microprocessor device, and various analog to digital converters, digital to analog converters, and/or other support circuits. Control and signal processing functions of the computing device system 400 are allocated between these devices according to their respective capabilities. The processor 410 thus may also include the functionality to encode and interleave messages and data prior to modulation and transmission. The processor 410 can additionally include an internal data modem. Further, the processor 410 may include functionality to operate one or more software programs, which may be stored in the memory 420. For example, the processor 410 may be capable of operating a connectivity program, such as a web browser application 422. The web browser application 422 may then allow the computing device system 400 to transmit and receive web content, such as, for example, location-based content and/or other web page content, according to a Wireless Application Protocol (WAP), Hypertext Transfer Protocol (HTTP), and/or the like.

The processor 410 is configured to use the network interface 460 to communicate with one or more other devices on the network 150. In this regard, the network interface 460 includes an antenna 476 operatively coupled to a transmitter 474 and a receiver 472 (together a “transceiver”). The processor 410 is configured to provide signals to and receive signals from the transmitter 474 and receiver 472, respectively. The signals may include signaling information in accordance with the air interface standard of the applicable cellular system of the wireless network 152. In this regard, the computing device system 400 may be configured to operate with one or more air interface standards, communication protocols, modulation types, and access types. By way of illustration, the computing device system 400 may be configured to operate in accordance with any of a number of first, second, third, and/or fourth-generation communication protocols and/or the like.

As described above, the computing device system 400 has a user interface that is, like other user interfaces described herein, made up of user output devices 436 and/or user input devices 440. The user output devices 436 include a display 430 (e.g., a liquid crystal display or the like) and a speaker 432 or other audio device, which are operatively coupled to the processor 410.

The user input devices 440, which allow the computing device system 400 to receive data from a user such as the user 110, may include any of a number of devices allowing the computing device system 400 to receive data from the user 110, such as a keypad, keyboard, touch-screen, touchpad, microphone, mouse, joystick, other pointer device, button, soft key, and/or other input device(s). The user interface may also include a camera 480, such as a digital camera.

The computing device system 400 may also include a positioning system device 475 that is configured to be used by a positioning system to determine a location of the computing device system 400. For example, the positioning system device 475 may include a GPS transceiver. In some embodiments, the positioning system device 475 is at least partially made up of the antenna 476, transmitter 474, and receiver 472 described above. For example, in one embodiment, triangulation of cellular signals may be used to identify the approximate or exact geographical location of the computing device system 400. In other embodiments, the positioning system device 475 includes a proximity sensor or transmitter, such as an RFID tag, that can sense or be sensed by devices known to be located proximate a merchant or other location to determine that the computing device system 400 is located proximate these known devices.

The computing device system 400 further includes a power source 415, such as a battery, for powering various circuits and other devices that are used to operate the computing device system 400. Embodiments of the computing device system 400 may also include a clock or other timer 450 configured to determine and, in some cases, communicate actual or relative time to the processor 410 or one or more other devices.

The computing device system 400 also includes a memory 420 operatively coupled to the processor 410. As used herein, memory includes any computer readable medium (as defined herein below) configured to store data, code, or other information. The memory 420 may include volatile memory, such as volatile Random Access Memory (RAM) including a cache area for the temporary storage of data. The memory 420 may also include non-volatile memory, which can be embedded and/or may be removable. The non-volatile memory can additionally or alternatively include an electrically erasable programmable read-only memory (EEPROM), flash memory or the like.

The memory 420 can store any of a number of applications which comprise computer-executable instructions/code executed by the processor 410 to implement the functions of the computing device system 400 and/or one or more of the process/method steps described herein. For example, the memory 420 may include such applications as a conventional web browser application 422, a real-time code review application 421, entity application 424. These applications also typically instructions to a graphical user interface (GUI) on the display 430 that allows the user 110 to interact with the entity system 200, the real-time code review system 300, and/or other devices or systems. The memory 420 of the computing device system 400 may comprise a Short Message Service (SMS) application 423 configured to send, receive, and store data, information, communications, alerts, and the like via the wireless telephone network 152. In some embodiments, the real-time code review application 421 provided by the real-time code review system 300 allows the user 110 to access the real-time code review system 300. The real-time code review application 421 allows the real-time code review system 300 to capture and record the review sessions and also provide real-time feedback to the users 110 during the review sessions. In some embodiments, the entity application 424 provided by the entity system 200 and the real-time code review application 421 allow the user 110 to access the functionalities provided by the real-time code review system 300 and the entity system 200.

The memory 420 can also store any of a number of pieces of information, and data, used by the computing device system 400 and the applications and devices that make up the computing device system 400 or are in communication with the computing device system 400 to implement the functions of the computing device system 400 and/or the other systems described herein.

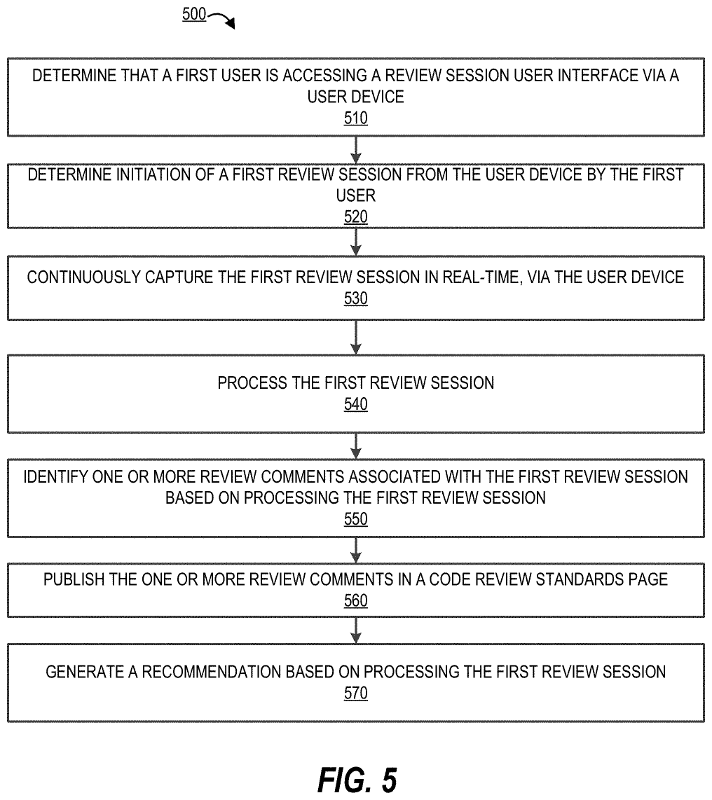

FIG. 5 provides a flowchart illustrating a process flow for providing real-time feedback during software code build and review sessions, in accordance with an embodiment of the invention.

As shown in block 510, the system determines that a first user is accessing a review session user interface via a user device. The first user may be an application developer, an application tester, an application owner, or the like. Review session user interface may be associated with a platform that is provided by the system, where one or more users of the entity utilize the review session user interface to conduct review sessions associated with software codes associated with one or more entity applications of the entity.

As shown in block 520, the system determines initiation of a first review session from the user device by the first user. Any of the one or more users may enter credentials into review session user interface to attend a review session via user devices, where the user devices are provided by the entity. Upon successful authentication of the first user and a plurality of users of the one or more users, the system prompts the first user and the plurality of users to provide a voice input. In response to receiving the voice input, the system associates or tags each of the voice input with a user reference identifier associated with the each of the first user and the plurality of users.

As shown in block 530, the system continuously captures the first review session in real-time, via the user device. The system causes the user device to capture the first review session via a listening component (e.g., microphone) of the user device. The system causes the user device to capture and transmit the real-time feed of the first review session to the system and/or the entity system.

As shown in block 540, the system processes the first review session. The system may use an intelligent language processor to process the first review session. In some embodiments, the system may process the first review session in real-time. In some embodiments, the system may process the first review session after completion of the first review session.

As shown in block 550, the system identifies one or more review comments associated with the first review session based on processing the first review session. The one or more review comments may be provided by the first user or the plurality of the users participating in the first review session, where the one or more review comments are associated with the one or more codes. The one or more review comments may be associated with coding standards, code errors, business requirements, domain requirements, or the like. The system via the intelligent language processor identifies the one or more review comments associated with the real-time feed of the first review session. In some embodiments, the system may track the each user (e.g., first user, second user, third user, or the like) associated with each of the one or more review comments (e.g., first review comment, second review comment, third review comment, or the like).

As shown in block 560, the system publishes the one or more review comments in a code review standards page. In some embodiments, the system publishes review comments associated with the one or more code review sessions individually. In some other embodiments, the system in response to identifying the one or more review comments from one or more review sessions conducted by one or more users of the entity, consolidates the one or more review comments and generates one or more code review standards based on consolidating the one or more review comments. The system then publishes the one or more code review standards in the code review standards page. In some embodiments, the system after publishing the one or more review comments in the code review standards page, transmits a link associated with the code review standards page to the first user and the plurality of users. In some embodiments, the system displays the code review standards page via the review session user interface. The system then prompts the first user and the plurality of users to submit feedback associated with the one or more review comments and/or one or more code review standards in the code review standards page. In response to receiving feedback from the first user and/or the plurality of users, the system updates the code review standards page based on the feedback.

As shown in block 570, the system generates a recommendation based on processing the first review session. At the end of the review session, the system generates a recommendation, where the recommendation is associated with at least one review comment or a code review standard that was discussed during the live review session.

In some embodiments, at the end of the review session, the system may generate a summary of the first review session and may transmit the summary to the first user and the plurality of the users, where the summary comprises information associated with the participants, one or more review comments discussed during the first review session, or the like. In some embodiments, the system displays the summary of the first review session on the review session user interface.

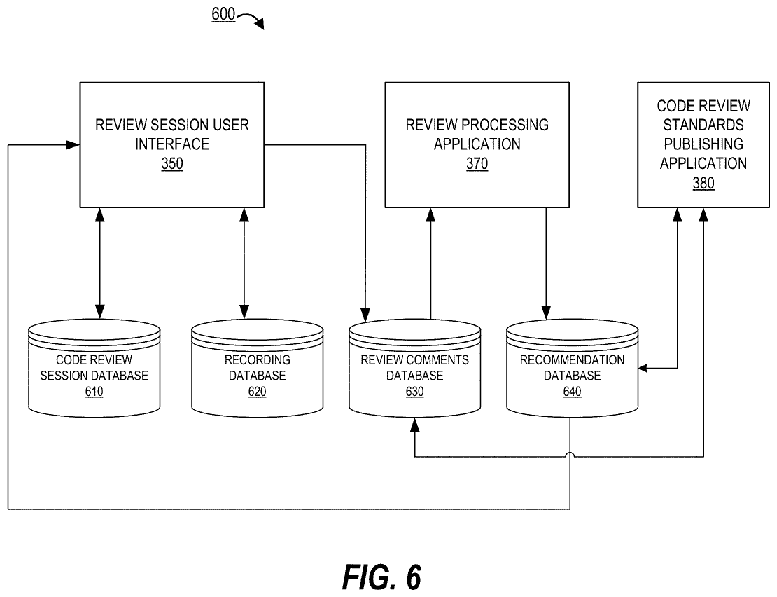

FIG. 6 provides a block diagram illustrating an architecture for providing real-time feedback during software code build and review sessions, in accordance with an embodiment of the invention. As shown, the system identifies that a user is logging in or accessing the review session user interface 350 to initiate a review session or participate in the review session. The user credentials, voice input, or the like provided by the one or more users while logging into the review session user interface 350 are stored in the code review session database 610. The system may then continuously capture the real-time review sessions via the user devices of the one or more users and store the real-time feed of the review session in the recording database 620. The real-time feed of the review session is passed onto the review processing application 370 for processing, where the review processing application 370 identifies one or more review comments associated with the review sessions and stores the one or more review comments in the review comments database 630. The review processing application 370 also generates one or more recommendations associated with the review session and stores the one or more recommendations in the recommendation database 640. The code review standards publishing application 380 publishes one or more review comments from the review comments database 630 and the one or more recommendations in the recommendation database 640 in a code review standards page. The code review standards publishing application 380 also prompts the one or more users to provide feedback associated with the one or more review comments and the one or more code review standards and then updates the recommendation data 640 and review comments database 630 based on the feedback.

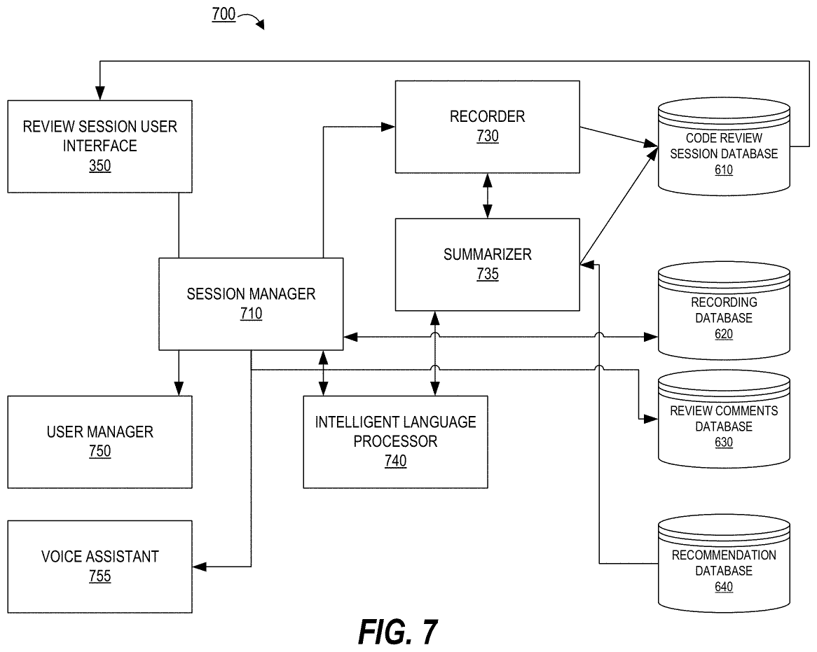

FIG. 7 provides a block diagram illustrating an architecture for capturing real-time review sessions, in accordance with an embodiment of the invention. The review session interface 350 further comprises one or more components as shown in FIG. 7. As shown, the session manager 710 manages one or more review sessions and further communicates with the user manager 750 to manage participants of the one or more review sessions and a voice assistant 755 to track the voices of the participants of the one or more review sessions. The recorder 730 generates a final recording based on the real-time time feed received form the user devices and stores the recording in the code review session database 610. The intelligent language processor 740 processes the real-time feed received from the user devices and passes the identified one or more review comments and other information associated with the one or more review sessions to the recorder 730 and the summarizer 735. The summarizer generates summaries of the one or more review sessions and stores the summary in the code review session database 610. The recommendations generated by the review processing application 370 are included in the summary generated by the summarizer 735. The session manager 710 also stores the recording and the identified review comments in the recording database 620 and the review comments database 630 respectively.

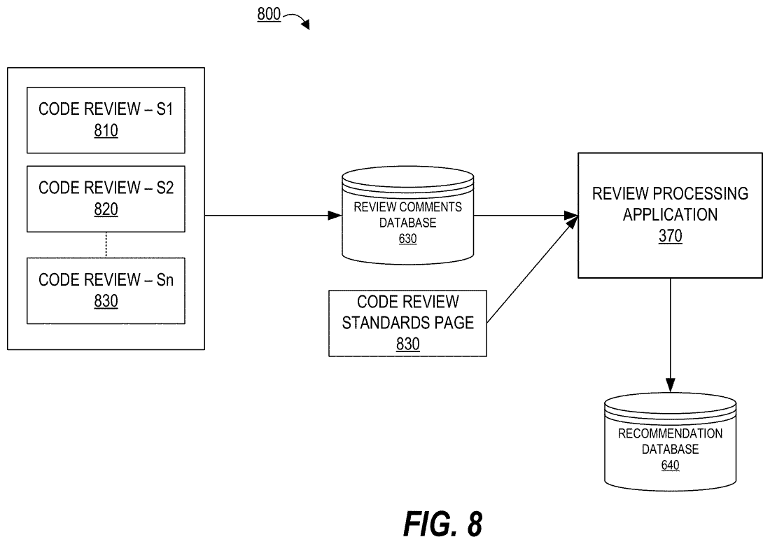

FIG. 8 provides a block diagram illustrating an architecture for processing the real-time review sessions, in accordance with an embodiment of the invention. As shown, the review processing application 370 based on (i) one or more code review comments associated with the one or more code review sessions (e.g., Code Review-S1, Code Review-S2, through Code Review-Sn) stored in the review comments database 630 and (ii) the code review standards that are published on the code review standards page 830 generates recommendations associated with the one or more code review sessions and stores the recommendations in the recommendation database 640.

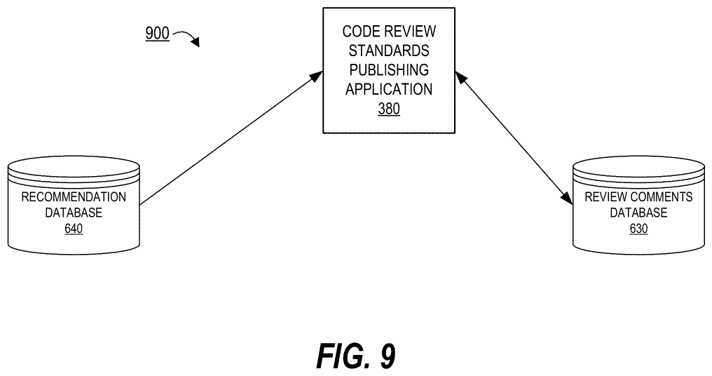

FIG. 9 provides a block diagram illustrating an architecture for publishing code review standards in an code review standards page, in accordance with an embodiment of the invention. The code review standards publishing application 380 takes the recommendations from the recommendation database 640 and the review comments from the review comments database 630 and publishes in the code review standards page. The code review standards publishing application 380 then receives feedback from the one or more users and updates the review comments database 630 as explained above.

Typically, conventional systems are very static, where the conventional systems scan software codes and provided static feedback on errors associated with the software codes. The system of the present invention processes software codes associated with multiple applications and supports multiple review sessions conducted by multiple users to provide dynamic feedback in real-time to the one or more users and in turn provide a summary of the review sessions to the one or more users such that all the review comments are addressed to fix the issues associated with the software codes. The system of the present invention therefore avoids the possibility of pulling back the software code after deployment into the production environment to readdress the issues with the software codes that were originally discussed during the review sessions. As such, the system of the present invention improves the overall efficiency of the software development process.

As will be appreciated by one of skill in the art, the present invention may be embodied as a method (including, for example, a computer-implemented process, a business process, and/or any other process), apparatus (including, for example, a system, machine, device, computer program product, and/or the like), or a combination of the foregoing. Accordingly, embodiments of the present invention may take the form of an entirely hardware embodiment, an entirely software embodiment (including firmware, resident software, micro-code, and the like), or an embodiment combining software and hardware aspects that may generally be referred to herein as a “system.” Furthermore, embodiments of the present invention may take the form of a computer program product on a computer-readable medium having computer-executable program code embodied in the medium.

Any suitable transitory or non-transitory computer readable medium may be utilized. The computer readable medium may be, for example but not limited to, an electronic, magnetic, optical, electromagnetic, infrared, or semiconductor system, apparatus, or device. More specific examples of the computer readable medium include, but are not limited to, the following: an electrical connection having one or more wires; a tangible storage medium such as a portable computer diskette, a hard disk, a random access memory (RAM), a read-only memory (ROM), an erasable programmable read-only memory (EPROM or Flash memory), a compact disc read-only memory (CD-ROM), or other optical or magnetic storage device.

In the context of this document, a computer readable medium may be any medium that can contain, store, communicate, or transport the program for use by or in connection with the instruction execution system, apparatus, or device. The computer usable program code may be transmitted using any appropriate medium, including but not limited to the Internet, wireline, optical fiber cable, radio frequency (RF) signals, or other mediums.

Computer-executable program code for carrying out operations of embodiments of the present invention may be written in an object oriented, scripted or unscripted programming language such as Java, Perl, Smalltalk, C++, or the like. However, the computer program code for carrying out operations of embodiments of the present invention may also be written in conventional procedural programming languages, such as the “C” programming language or similar programming languages.

Embodiments of the present invention are described above with reference to flowchart illustrations and/or block diagrams of methods, apparatus (systems), and computer program products. It will be understood that each block of the flowchart illustrations and/or block diagrams, and/or combinations of blocks in the flowchart illustrations and/or block diagrams, can be implemented by computer-executable program code portions. These computer-executable program code portions may be provided to a processor of a general purpose computer, special purpose computer, or other programmable data processing apparatus to produce a particular machine, such that the code portions, which execute via the processor of the computer or other programmable data processing apparatus, create mechanisms for implementing the functions/acts specified in the flowchart and/or block diagram block or blocks.

These computer-executable program code portions may also be stored in a computer-readable memory that can direct a computer or other programmable data processing apparatus to function in a particular manner, such that the code portions stored in the computer readable memory produce an article of manufacture including instruction mechanisms which implement the function/act specified in the flowchart and/or block diagram block(s).

The computer-executable program code may also be loaded onto a computer or other programmable data processing apparatus to cause a series of operational steps to be performed on the computer or other programmable apparatus to produce a computer-implemented process such that the code portions which execute on the computer or other programmable apparatus provide steps for implementing the functions/acts specified in the flowchart and/or block diagram block(s). Alternatively, computer program implemented steps or acts may be combined with operator or human implemented steps or acts in order to carry out an embodiment of the invention.

As the phrase is used herein, a processor may be “configured to” perform a certain function in a variety of ways, including, for example, by having one or more general-purpose circuits perform the function by executing particular computer-executable program code embodied in computer-readable medium, and/or by having one or more application-specific circuits perform the function.

Embodiments of the present invention are described above with reference to flowcharts and/or block diagrams. It will be understood that steps of the processes described herein may be performed in orders different than those illustrated in the flowcharts. In other words, the processes represented by the blocks of a flowchart may, in some embodiments, be in performed in an order other that the order illustrated, may be combined or divided, or may be performed simultaneously. It will also be understood that the blocks of the block diagrams illustrated, in some embodiments, merely conceptual delineations between systems and one or more of the systems illustrated by a block in the block diagrams may be combined or share hardware and/or software with another one or more of the systems illustrated by a block in the block diagrams. Likewise, a device, system, apparatus, and/or the like may be made up of one or more devices, systems, apparatuses, and/or the like. For example, where a processor is illustrated or described herein, the processor may be made up of a plurality of microprocessors or other processing devices which may or may not be coupled to one another. Likewise, where a memory is illustrated or described herein, the memory may be made up of a plurality of memory devices which may or may not be coupled to one another.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

1. A system for providing real-time feedback during software code build and review sessions, the system comprising:
at least one network communication interface;
at least one non-transitory storage device; and
at least one processing device coupled to the at least one non-transitory storage device and the at least one network communication interface, wherein the at least one processing device is configured to:
determine that a first user is accessing a review session user interface via a user device;
determine initiation of a first real-time live review session from the user device by the first user, wherein the first real-time live review session involves review of a software code associated with an entity application that is developed by at least one of the first user and a plurality of users;
continuously capture the first real-time live review session in real-time, via the user device, wherein capturing the first real-time live review session comprises recording one or more review comments provided by the first user and the plurality of users;
in response to capturing the first real-time live review session, process the first real-time live review session; and
generate a recommendation based on processing the first real-time live review session, wherein the recommendation is associated with the one or more review comments that are associated with the first real-time live review session.

2. The system of claim 1, wherein the at least one processing device is configured to:
generate a summary of the first real-time live review session;
display the summary on the real-time live review session user interface; and
transmit the summary to the first user and the plurality of users.

3. The system of claim 1, wherein the at least one processing device is configured to:
identify the one or more review comments associated with the software code from the first real-time live review session and tag each of the one or more review comments to at least one of the first user and the plurality of the users; and
publish the one or more review comments in a code review standards page.

4. The system of claim 3, wherein the at least one processing device is configured to:
display the code review standards page to the first user and the plurality of users via the review session user interface;
prompt the first user and the plurality of users to submit feedback associated with the one or more review comments in the code review standards page;
receive the feedback from at least one of the first user and the plurality of users; and
update the code review standards page based on the feedback.

5. The system of claim 3, wherein the at least one processing device is configured to store the one or more review comments in a review comments database.

6. The system of claim 1, wherein the at least one processing device is configured to store recording associated with the first real-time live review session in a recording database.

7. The system of claim 1, wherein the at least one processing device is configured to:
in response to determining that the first user is accessing the review session user interface, prompt the first user to provide a voice input;
associate the voice input with credentials of the first user; and
store the voice input in a code review session database.

8. A computer program product for providing real-time feedback during software code build and review sessions, the computer program product comprising at least one non-transitory computer-readable medium having computer-readable program code portions embodied therein, the computer-readable program code portions comprises one or more executable portions for:
determining that a first user is accessing a review session user interface via a user device;
determining initiation of a first real-time live review session from the user device by the first user, wherein the first real-time live review session involves review of a software code associated with an entity application that is developed by at least one of the first user and a plurality of users;
continuously capturing the first real-time live review session in real-time, via the user device, wherein capturing the first real-time live review session comprises recording one or more review comments provided by the first user and the plurality of users;
in response to capturing the first real-time live review session, processing the first real-time live review session; and
generating a recommendation based on processing the first real-time live review session, wherein the recommendation is associated with the one or more review comments that are associated with the first real-time live review session.

9. The computer program product of claim 8, wherein the computer-readable program code further comprises one or more executable portions for:
generating a summary of the first real-time live review session;
displaying the summary on the review session user interface; and
transmitting the summary to the first user and the plurality of users.

10. The computer program product of claim 8, wherein the more processing devices are configured to execute the computer readable code to computer-readable program code further comprises one or more executable portions for:
identifying the one or more review comments associated with the software code from the first real-time live review session and tag each of the one or more review comments to at least one of the first user and the plurality of the users; and
publishing the one or more review comments in a code review standards page.

11. The computer program product of claim 10, wherein the computer-readable program code further comprises one or more executable portions for:
displaying the code review standards page to the first user and the plurality of users via the review session user interface;
prompting the first user and the plurality of users to submit feedback associated with the one or more review comments in the code review standards page;
receiving the feedback from at least one of the first user and the plurality of users; and
updating the code review standards page based on the feedback.

12. The computer program product of claim 10, wherein the computer-readable program code further comprises one or more executable portions for storing the one or more review comments in a review comments database.

13. The computer program product of claim 8, wherein the computer-readable program code further comprises one or more executable portions for storing recording associated with the first real-time live review session in a recording database.

14. The computer program product of claim 8, wherein the computer-readable program code further comprises one or more executable portions for:
in response to determining that the first user is accessing the review session user interface, prompt prompting the first user to provide a voice input;
associating the voice input with credentials of the first user; and
storing the voice input in a code review session database.

15. A computer implemented method for providing real-time feedback during software code build and review sessions, the method comprises:
determining that a first user is accessing a review session user interface via a user device;
determining initiation of a first real-time live review session from the user device by the first user, wherein the first real-time live review session involves review of a software code associated with an entity application that is developed by at least one of the first user and a plurality of users;
continuously capturing the first real-time live review session in real-time, via the user device, wherein capturing the first real-time live review session comprises recording one or more review comments provided by the first user and the plurality of users;
in response to capturing the first real-time live review session, processing the first real-time live review session; and
generating a recommendation based on processing the first real-time live review session, wherein the recommendation is associated with the one or more review comments that are associated with the first real-time live review session.

16. The computer implemented method of claim 15, wherein the method further comprises:
generating a summary of the first real-time live review session;
displaying the summary on the review session user interface; and
transmitting the summary to the first user and the plurality of users.

17. The computer implemented method of claim 15, wherein the method further comprises:
identifying the one or more review comments associated with the software code from the first real-time live review session and tagging each of the one or more review comments to at least one of the first user and the plurality of the users; and
publishing the one or more review comments in a code review standards page.

18. The computer implemented method of claim 17, wherein the method further comprises:
displaying the code review standards page to the first user and the plurality of users via the review session user interface;
prompting the first user and the plurality of users to submit feedback associated with the one or more review comments in the code review standards page;
receiving the feedback from at least one of the first user and the plurality of users; and
updating the code review standards page based on the feedback.

19. The computer implemented method of claim 15, wherein the method further comprises:
in response to determining that the first user is accessing the review session user interface, prompting the first user to provide a voice input;
associating the voice input with credentials of the first user; and
storing the voice input in a code review session database.

20. The computer implemented method of claim 17, wherein the method further comprises storing the one or more review comments in a review comments database.
